(19) United States
(12) Patent Application Publication
(10) Pub. No.: US 2011/0208766 A1
(43) Pub. Date: Aug. 25, 2011

(54) SYSTEM AND METHOD FOR MANAGING PERSONAL INFORMATION

(75) Inventor: Joanne Lang, Malvern, PA (US)

(73) Assignee: ABOUTONE, LLC, Malvern, PA (US)

(21) Appl. No.: 13/033,598

(22) Filed: Feb. 23, 2011

Related U.S. Application Data
(60) Provisional application No. 61/307,143, filed on Feb. 23, 2010.

(51) Int. Cl. G06F 17/30

(52) U.S. Cl. 707/759; 707/E17.005

(57) ABSTRACT

The system includes a computing device, a receiving module, a storage device, a build-out module and a leveraging module. The computing device includes a processor. The receiving module is communicably connected to the processor and is configured to receive personal information. The storage device is communicably connected to the processor and is configured to store the received personal information. The build out module is communicably connected to the processor and is configured to automatically retrieve additional personal information based on the received personal information. The leverage module is communicably connected to the processor and is configured to utilize the stored information to automatically perform an organizational task historically performed by a person.

### CROSS-REFERENCE TO RELATED APPLICATION

This application claims the benefit under 35 U.S.C. §119(e) of the earlier filing date of U.S. Provisional Application Ser. No. 61/307,143 filed on Feb. 23, 2010, the entire contents of which are hereby incorporated by reference.

### BACKGROUND

This application discloses an invention which is related, generally and in various embodiments, to a system and method for managing personal information.

For many years, people have labored to organize and store personal and other related information. Current systems utilized for organizing such information include paper-based filing systems, electronic filing systems (e.g., digital filing cabinets) for digitally storing paper documents, software-based systems deployed over the Internet (e.g., software as a service/software on demand) for backing up digital files and/or managing specialized segments of information (e.g., photographs, financial documents, health information, etc.).

Paper-based filing systems have been utilized for centuries. Such systems range from ad-hoc storage systems which can be as simple as storing the documents without organization in a shoe box, to elaborately planned systems where documents are assigned numbers and filed in folders and drawers with some type of written index. The information is typically stored at a single geographic location, and a user needs to be at the geographic location in order to access the stored information. In general, these paper-based systems rely on a user to create a logical system for storing the information so that the information can be more efficiently retrieved at a later time. As more and more documents are added to the paper-based filing system, more and more physical space is required to store the documents, and the ability to retrieve a particular piece of information becomes increasingly complex. For example, for systems which are organized based on key words, the efficient retrieval of a particular piece of information requires an understanding of both the logical organization of the system and the key word associated with the particular piece of information.

Many paper-based systems also lack a desired level of consistency regarding where a given document is filed and subsequently re-filed within the system. For example, even when the users of the system exhibit a great deal of discipline regarding where documents are filed, it is not uncommon for one user to file a document in a first position within the filing system, then at a later point in time have the same or another user re-file the document in a different position within the filing system. Thus, as documents are not always where they are supposed to be within the filing system, the process of locating a desired document is not always as efficient as expected. Additionally, with paper-based systems, the documents need to be protected from risk of loss due to disasters such as fire, flood, etc.

Following the introduction of stand-alone home computers, electronic filing systems and electronic document management systems have been developed as an alternative to paper-based systems. These systems store digitized versions of documents/information and may be implemented in various forms such as, for example, an electronic spreadsheet, a specially designed software application that runs on the stand-alone computer, etc. Because the information is stored at the stand-alone home computer, a user needs to be at the geographic location of the stand-alone home computer in order to access the stored information. In contrast to paper-based systems, most of the electronic filing systems are configured to utilize multiple key words to index the stored information. Therefore, searching for a particular piece of information is typically much easier than with paper-based systems.

However, the improved functionality over paper-based systems does not come without a cost. The overall cost of implementing electronic filing systems tends to be greater than the cost of paper-based systems due to the cost of the required hardware (e.g., a computing device, a storage device, a scanner, etc.). Also, as the amount of stored information increases, upgrades to the system's software, processing power and/or memory may be necessary, thereby further increasing the cost. Furthermore, the electronic filing systems generally rely on the users to ensure that the associated software is current (e.g., the most recent upgrade has been installed), that the stored information is secure (e.g., by requiring a password to access the stored information, encryption, firewalls, etc.) and that risk of loss has been minimized (e.g., by periodically backing up the stored information). As not all users possess the same skill set and diligence, the operation of the electronic filing system, the actual level of security realized and the actual risk of loss for these systems are less than optimal.

In the late 1990s, technology advancements in new supplement, consumption and delivery models for IT services based on the Internet changed the way software can be designed. With cloud computing technology, a user can utilize a web browser to access a software application residing at a server which is located anywhere in the world (e.g., at a geographic location other than the geographic location of the user), and the information input by the user can be stored at a location remote from the user. By definition clouds have five essential characteristics: on-demand self-service; broad network access; resource pooling; rapid elasticity; and measured service.

The above-described changes in available technology led to the development of “software as a service” (SaaS) applications. Although the currently available applications have increased the storage capacity and processing power available to a user without the associated added cost burden, they only tend to focus on small segments of the personal information. For example, some applications are specifically configured to manage financial information, whereas other applications are specifically configured to manage photographs, health, upcoming events, etc.

With this type of disparate application approach, where the respective applications are not configured to organize, store and manage all of the varied information associated with a given user, the same information typically needs to be input into a plurality of different applications, the information is not shared between the applications and the user is unable to link information together from different applications. Therefore, with these types of software-based systems, the user needs to access several different applications in order to retrieve all of the desired personal information. Although searching for stored information is relatively easy within each individual application, the ability to seamlessly search across the whole range of personal information is lacking, and obtaining the desired information can be more complicated than with other filing systems. Because the currently available software-based systems do not address all of the various types of personal information to be organized and stored, the users of such systems must still rely on paper-based and/or other methods to organize, store and manage all of the desired information.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of a system;

FIG. 2 illustrates various embodiments of a computing system of the system of FIG. 1;

FIG. 3 illustrates other embodiments of the system of FIG. 1;

FIG. 4 illustrates various embodiments of a method; and

FIGS. 5-22 are exemplary screen shots of a user interface of the system of FIG. 1.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

As described in more detail hereinbelow, aspects of the invention may be implemented by a computing device and/or a computer program stored on a computer-readable medium. The computer-readable medium may comprise a disk, a device, and/or a propagated signal.

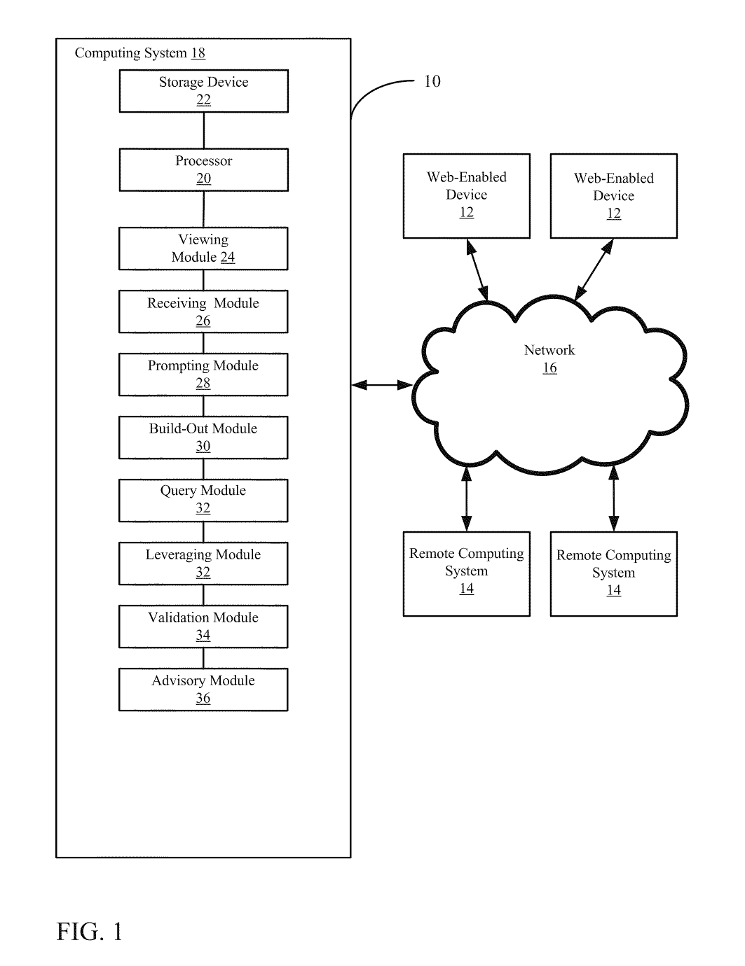

FIG. 1 illustrates various embodiments of a system 10. As described in more detail hereinbelow, the system 10 may be utilized to store and organize personal information. The personal information may include any information associated with the user. Such information may include information which is directly related to the user (e.g., the user's household information (e.g., home address, mobile telephone number, home improvement/repair records, etc.), medical information (e.g., blood type, allergies, insurance policy numbers, medical records, etc.), legal information (e.g., a will, a life insurance policy, a contract, etc.), educational information (e.g., names of institutions attended, dates attended, degrees earned, etc.), employment information (e.g., names, addresses and telephone numbers of former employers, dates employed by former employers, positions held, responsibilities at former employers, contact information for former supervisors, etc.), identification information (e.g., social security number, driver's license number, etc.), and financial information (e.g., checking account numbers, credit card numbers, loan numbers, retirement account numbers, tax records, etc.)) as well as personal journals, photographs, videos, etc.

Such information may also include information regarding members of the user's immediate family (e.g., birthdays, wedding anniversaries, mailing addresses, telephone numbers, medical information, educational information, employment information, identification information, employer information, identification information, financial information, etc.) as well as family photographs, videos, children's artwork, etc. Such information may further include information regarding members of the user's extended family, friends of the user, business associates of the user, etc. Additionally, it will be appreciated that the system 10 may be utilized to store and organize personal information for any number of people (e.g., subscribers).

As shown in FIG. 1, the system 10 may be communicably connected to a plurality of web-enabled devices 12 and to a plurality of remote computer systems 14 via a network 16. Although only two web-enabled devices 12 and two computer systems 14 are shown as being communicably connected to the system 10 in FIG. 1, it will be appreciated that the system 10 may be communicably connected with any number of web-enabled devices 12 and/or computer systems 14.

The web-enabled devices 12 may be any suitable type of web-enabled devices (i.e., devices which include a web browser) such as, for example, a desktop computer, a laptop, a notebook, a tablet, a smart phone, etc. The web-enabled devices 12 include a graphical user interface which allows a user to input information into the web browser of the web-enabled device 12 for subsequent transmission to the system 10 via the network 16. The graphical user interface also allows a user to view information retrieved from the system 10 by the web browser of the web-enabled device 12.

Each remote computing system 14 may include any number of computing devices communicably connected to one another. Each remote computing system 14 may also include one or more storage devices having one or more databases residing thereon. As the system 10 is communicably connected to the remote computing systems 14, various types of information from the databases, including information associated with a user of the system 10, may be accessed by the system 10.

The network 16 may include any type of delivery system including, but not limited to, a local area network (e.g., Ethernet), a wide area network (e.g. the Internet and/or World Wide Web), a telephone network (e.g., analog, digital, wired, wireless, PSTN, ISDN, GSM, GPRS, and/or xDSL), a packet-switched network, a radio network, a television network, a cable network, a satellite network, and/or any other wired or wireless communications network configured to carry data. The network 16 may include elements, such as, for example, intermediate nodes, proxy servers, routers, switches, and adapters configured to direct and/or deliver data. In general, the system 10 may be structured and arranged to communicate with the web-enabled devices 12 and computer systems 14 via the network 16 using various communication protocols (e.g., HTTP, TCP/IP, UDP, WAP, WiFi, Bluetooth) and/or to operate within or in concert with one or more other communications systems.

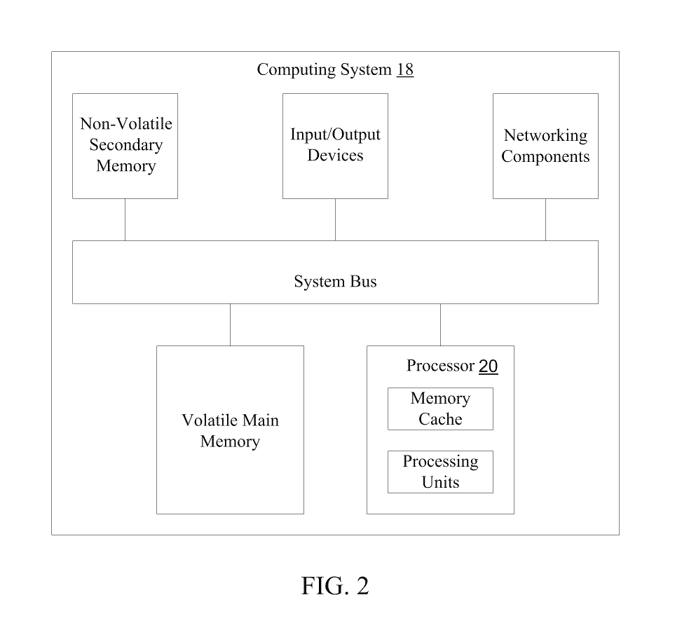

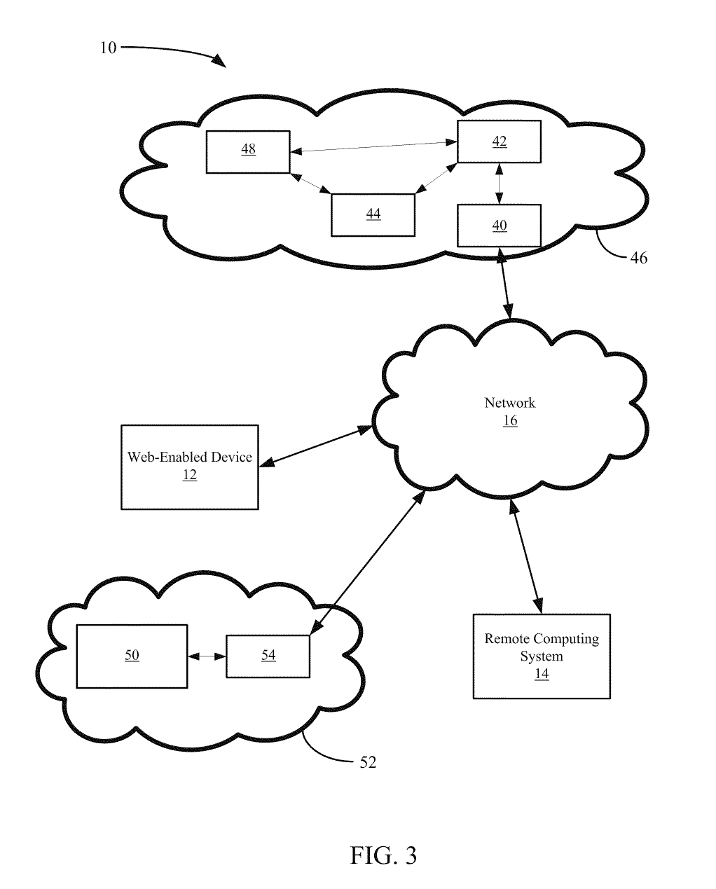

The system 10 includes a computing system 18. The computing system 18 includes a computing device that includes a processor 20, and a storage device 22 having a database stored thereon. The computing device may be any suitable type of computing device (e.g., a server, a desktop, a laptop, etc.). Of course, according to various embodiments, the computing system 18 may include any number of computing devices, processors and storage devices communicably connected to one another. Various embodiments of the computing system 18 are described in more detail hereinbelow with respect to FIGS. 2 and 3.

According to various embodiments, the system 10 includes the following modules: a viewing module 24, a receiving module 26, a prompting module 28, a build-out module 30, a query module 32, a leveraging module 34 and an advisory module 36. Each of the modules 24-36 may be communicably connected to the processor 20 and to one another.

The viewing module 24 is configured to present a view page (e.g., a web page) to a user via a web browser of a web-enabled device (e.g., web-enabled device 12). The viewing module 24 may present any number of different view pages to a user, and the various view pages operate as a user interface to the system 10. According to various embodiments, the view page includes a plurality of fields into which the user can enter information. The viewing module 24 is also configured to format information for presentation to a user via a view page. The information includes, for example, information received from a user via a web-enabled device 12, information received from remote computing systems 14, information stored in the database at the storage device 22, etc. The viewing module 24 is configured to format the information in a variety of different ways such that identical information may be presented to the user in a plurality of different view pages.

The receiving module 26 is configured to receive the above-described personal information. Such information may be provided by a user via a web-enabled device 12. According to various embodiments, the system 10 receives information entered by a user in fields of a view page presented to the user via a web browser of a web-enabled device 12. Alternatively, the information entered by the user may be entered in fields of a view page presented to the user via a mobile web browser or specialized mobile application.

From the user's perspective, according to various embodiments, the data would be entered in various fields in sub-sections of the view page organized into life areas. Exemplary subsections may include, for example, family, health, education, lockbox, possessions, career, fun, goals, spirituality, finance, contacts, life milestones and checklists, etc. For example, the user could enter basic data (e.g., birth date, name, blood type) about a family member in a “family” sub-section and other details like information about their home in the “possessions” sub-section. The system 10 stores the received information based on predefined rules and certain triggers.

According to various embodiments, the received information may also be provided by one or more of the remote computer systems 14. For example, the system 10 may utilize an application programming interface (API) with Vinquery (an online vehicle database) to automatically access and store details about a user's vehicle (purchase price, year, make, model, engine type, etc.) after the user enters the vehicle's identification number into a field of a view page. The mechanism for utilizing such application programming interfaces with external databases is the build-out module 30 which is described in more detail hereinbelow.

The system 10 is configured to store the information received by the receiving module 26. According to various embodiments, the system 10 automatically stores the received information. According to other embodiments, the system 10 only stores the received information when a user selects a button on a view page to store the information presented on the view page. The system 10 may also be configured to apply encryption algorithms to the information before the information is stored, whereby the user is the only one who holds the encryption/decryption key, thereby making the stored information unreadable to anyone but the user.

According to various embodiments, the system 10 may be further configured to format the stored information (e.g., utilizing tags, labels, etc.) such that one or more portions of the stored information associated with a given user may be shared with one or more other persons as designated by the user, and different scopes of information may be shared with different persons or groups of persons. Thus, the user can designate who can or who can not see their personal information, as well as who can or who can not edit such information. For example, a user may “elect” to share his medical and financial information with his spouse and/or children, but only his educational information with a group of business associates. It will be appreciated that, in general, if any information is to be shared, the scope of information to be shared with family members will be greater than the scope of information to be shared with non-family members.

The prompting module 28 is configured to transmit a message which prompts a user to enter additional information into the system 10. According to various embodiments, the message is triggered based on information entered into the system 10 by the user. For example, when a user is entering information into a field of a view page regarding a birth date of a child, the prompting module 28 may transmit a message which is displayed on the view page and serves to prompt the user to enter additional information about the child (e.g., the day of the week the child was born, the hospital where the child was born, the doctor who delivered the child, etc.). The prompting module 28 may transmit any suitable type of message such as, for example, an electronic mail message, a facsimile message, a text message, a telephone message, an onscreen prompt, etc.).

The build-out module 30 is configured to automatically access and retrieve additional personal information based on information entered into the system 10 by the user. The build-out module 30 may access and retrieve the information from the database at the storage device 22 and/or from the databases of the remote computer systems 14. According to various embodiments, the build-out module 30 is communicably connected to mash-ups and various web services, and utilizes application programming interfaces to access and retrieve the additional personal information from the remote computer systems 14. Of course, the information retrieved by the build-out module 30 may be presented to a user via one or more view pages.

The query module 32 is configured to search for specific stored information (e.g., information stored in the database at storage device 22). According to various embodiments, a plurality of the view pages include a search box into which the user may enter information to be searched for. For example, if the user enters “John's Birthday” into the search box, the query module 32 will search the stored information for all instances related to “John's Birthday”. The query module 32 may utilize information which is visible to the user as well as information which is not visible to the user (e.g. metadata) to perform the search. Of course, the results of the search may be presented to a user via one or more view pages.

The leveraging module 34 is configured to utilize the stored information to automatically perform organizational tasks historically performed by the user. For example, according to various embodiments, the leveraging module 34 is able to utilize the stored information to automatically (1) generate a family newsletter which includes text, video, artwork, etc., (2) generate hardcover memory books with photos, facts, written memories, etc.), (3) arrange family memories in chronological order, (4) provide an opportunity to order Christmas cards which are then sent directly from the card company to the user's designated recipients, (5) provide suggestions for an anniversary gift based on the specific anniversary (e.g., the 25^{th} anniversary), (6) arrange portions of the stored information into different formats for college applications, tax forms, etc. and (7) generate a variety of printable “fact” sheets (e.g., reports) for family newsletters, health providers, caregivers, etc. Of course, it will be appreciated that according to various embodiments, the leveraging module 34 may be configured to automate a variety of other tasks historically performed by the user in addition to those described in the above examples.

With respect to the fact sheets generated by the leveraging module 34, the leveraging module 34 is configured to create various reports based on the personal information stored by the system 10. The leveraging module 34 has access to all of the stored information (i.e., from multiple areas of the user's life), and may utilize such information to generate and transmit any number of different reports. For example, according to various embodiments, the leveraging module 34 generates reports directed to the user's current financial condition, the user's current health, the user's current possessions, etc. and combinations thereof. Of course, the generated reports may be presented to the user on a view page.

The advisory module 36 is configured to determine a plurality of suggested organizational actions to improve the overall organization of the user. According to various embodiments, the advisory module 36 determines the suggested actions based on relevancy to the user's personal profile and information stored by the system 10. The suggested actions may be presented to the user on view pages. For example, after a user's financial and/or legal information has been received by the system 10, the advisory module 36 may determine that a copy of the user's will should also be stored on the system 10, and the suggested action (i.e., submitting a copy of the will) may be presented to the user on a view page.

Another example is based on a family member's age and school enrollment status. After such information has been received by the system 10, the advisory module 36 may determine that the user should start memorializing certain information to better prepare the family for an upcoming college application process. Such suggested actions may include, for example, suggesting that information be entered and recorded regarding awards earned by the student, extracurricular activities the student participated in, volunteer work performed by the student, etc. The actions suggested by the advisory module 36 may be presented to the user via a view page at any suitable time. For the college preparation example described above, the suggested actions may initially be presented prior to the student entering high school and may also be presented throughout the time the student is in high school. The suggested actions may also be presented in any suitable manner. For example, according to various embodiments, the suggested actions may be presented to the user via a view page while the user is logged into the system 10, via an electronic mail message, via a facsimile message, via a text message, via a telephone message, etc.

In general, by providing links, information and resources to the user, the advisory module 36 helps a user better understand what should be stored, describes the incremental steps to becoming more organized, and supports and encourages good organizational decision making by the user. For example, based on information already received by the system 10, the advisory module 36 determine that the user should consider starting to get organized for a college application process, identify links which include informative materials directed to the college application process, and communicate with one or more other modules of the system 10 so that the identified links are presented to the user. The advisory module 36 may also generate alerts when it is time to begin submitting college applications, financial aid applications, etc., and communicate with one or more other modules of the system 10 so that the alerts are presented to the user.

The modules 24-36 may be implemented in hardware, firmware, software and combinations thereof. For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The modules 24-36 (e.g., software application, computer program) may be stored on a computer-readable medium (e.g., disk, device, and/or propagated signal) such that when a computer reads the medium, the functions described herein are performed. According to various embodiments, the above-described functionality of the modules 24-36 may be combined into fewer modules, distributed differently amongst the modules, spread over additional modules, etc. For embodiments where the computing system 18 includes more than one computing device, the modules 24-36 may be distributed amongst a plurality of the computing devices.

FIG. 2 illustrates various embodiments of the computing system 18. The computing system 18 may be embodied as one or more computing devices, and includes networking components such as Ethernet adapters, non-volatile secondary memory such as magnetic disks, input/output devices such as keyboards and visual displays, volatile main memory, and a processor 20. Each of these components may be communicably connected via a common system bus. The processor 20 includes processing units and on-chip storage devices such as memory caches.

According to various embodiments, the computing system 18 includes one or more modules which are implemented in software, and the software is stored in non-volatile memory devices while not in use. When the software is needed, the software is loaded into volatile main memory. After the software is loaded into volatile main memory, the processor 20 reads software instructions from volatile main memory and performs useful operations by executing sequences of the software instructions on data which is read into the processor 20 from volatile main memory. Upon completion of the useful operations, the processor 20 writes certain data results to volatile main memory.

FIG. 3 illustrates other embodiments of the system 10. For such embodiments, in addition to the above-described modules 24-36 (not shown in FIG. 3 for purposes of clarity), the computing system 18 includes a firewall 40, an application server 42 and a database server 44. The application server 42 and the database server 44 may be implemented as virtualized servers within a host cloud 46. Application server 42 may include, for example, an Ubuntu web server utilizing Apache2 and Passenger. Periodic backups of the application server 42 and the database server 44 may be made to a virtualized server 48, which may also reside within the host cloud 46. One or more snapshots from the application server 42 and/or the database server 44 may be saved on virtualized server 48 at any time. According to various embodiments, up to seven snapshots from the both the application server 42 and the database server 44 may be saved on virtualized server 48 at any time. Although only one application server 42, one database server 44 and one virtualized server 48 is shown in FIG. 3, it will be appreciated that any number of such servers may reside within the host cloud 46.

Periodic backups of the information stored at the database server 44 may be transmitted through the network 16 to a data storage infrastructure 50 that resides within the cloud 52. According to various embodiments, the information transmitted from the database server 44 to the data storage infrastructure 50 is secure. For example, the transmitted information may be encrypted and/or pass through a firewall 54. The cloud 52 may be embodied, for example, as the Amazon S3 cloud, where the data storage infrastructure 50 is a collection of virtualized database servers within the Amazon S3 cloud. Stated differently, the data storage infrastructure 50 is a collection of machines with software that allows them to act like one data storage server although they may have thousands of machines spread over many physical locations. Thus, the data storage infrastructure 50 is an abstraction of a region within the cloud 52. According to various embodiments, the data is stored redundantly on multiple devices across multiple facilities in the cloud 52.

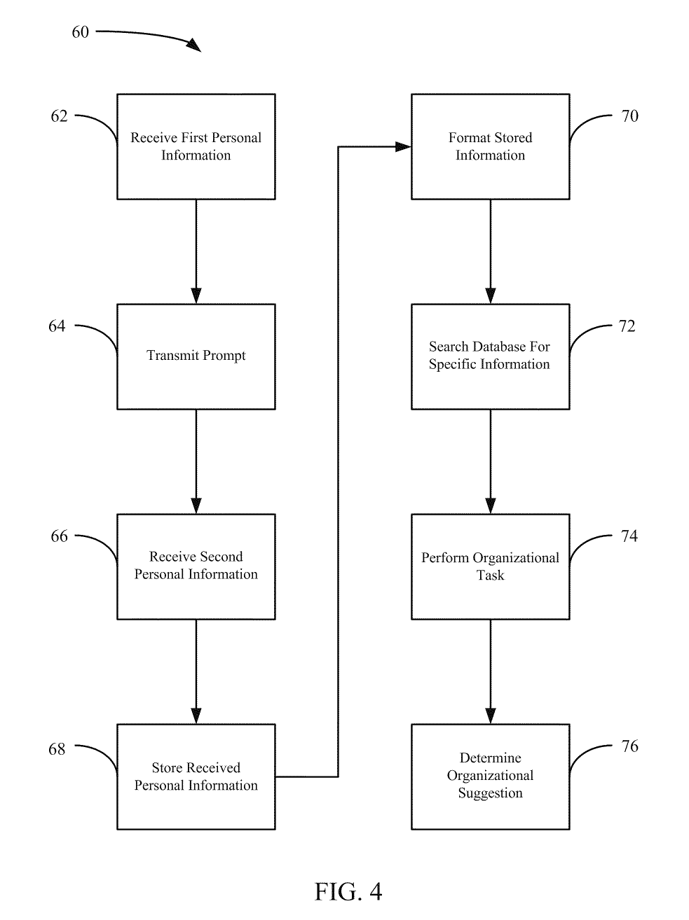

FIG. 4 illustrates various embodiments of a method 60. The method 60 may be utilized to store and manage the above-described personal information, and may be implemented by the system 10. This, it will be appreciated that the method 60 may be utilized o store and manage the above-described personal information for any number of people (e.g., subscribers). Although the method 60 may be implemented by systems other than system 10, for purposes of simplicity, the method 60 will be described in the context of being implemented by the system 10.

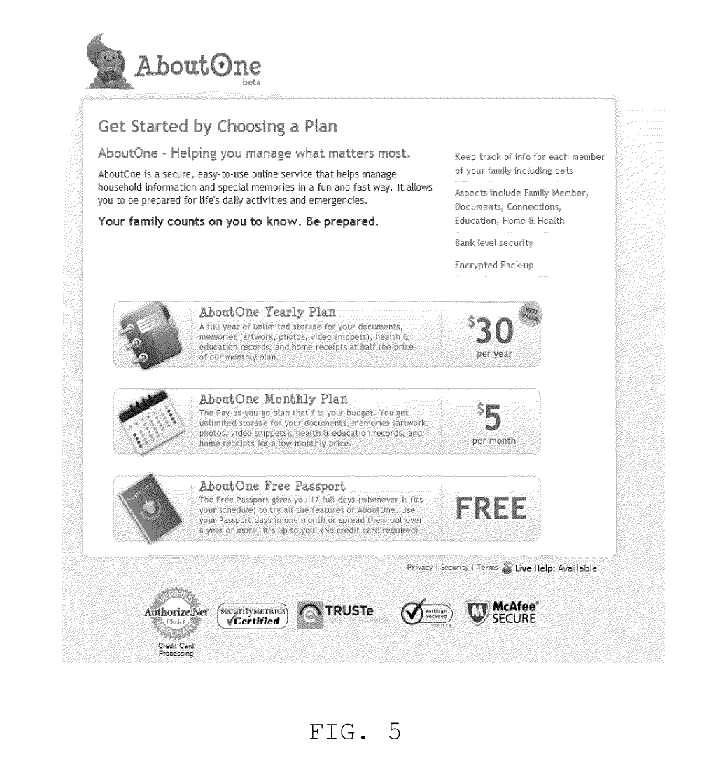

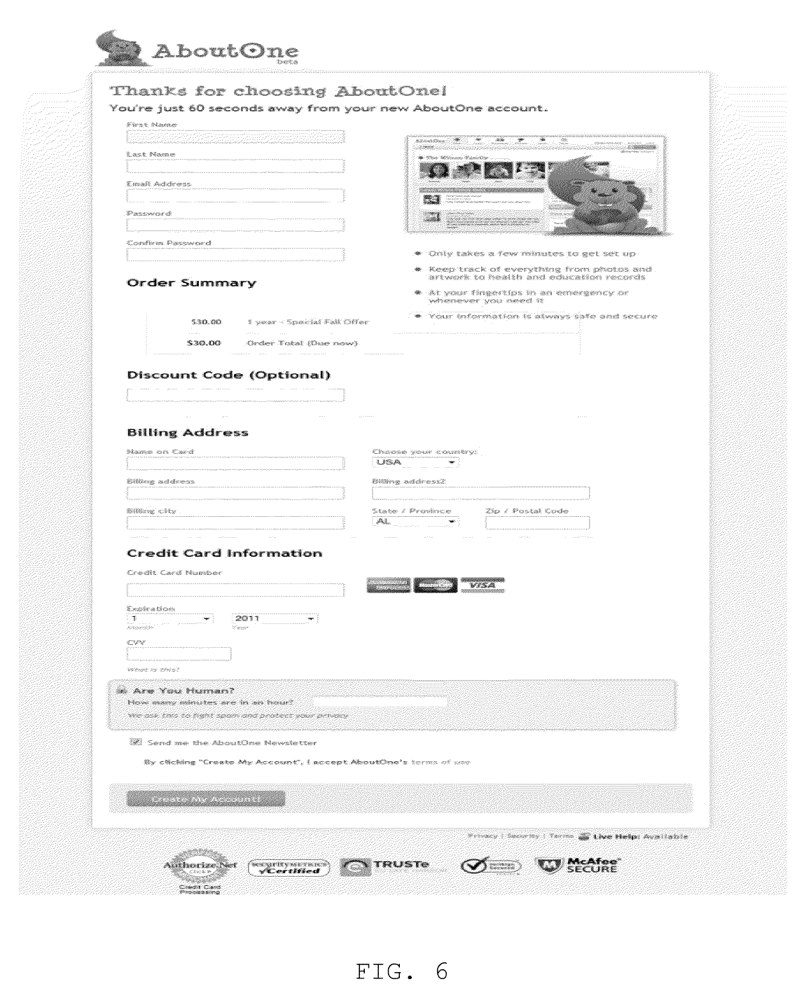

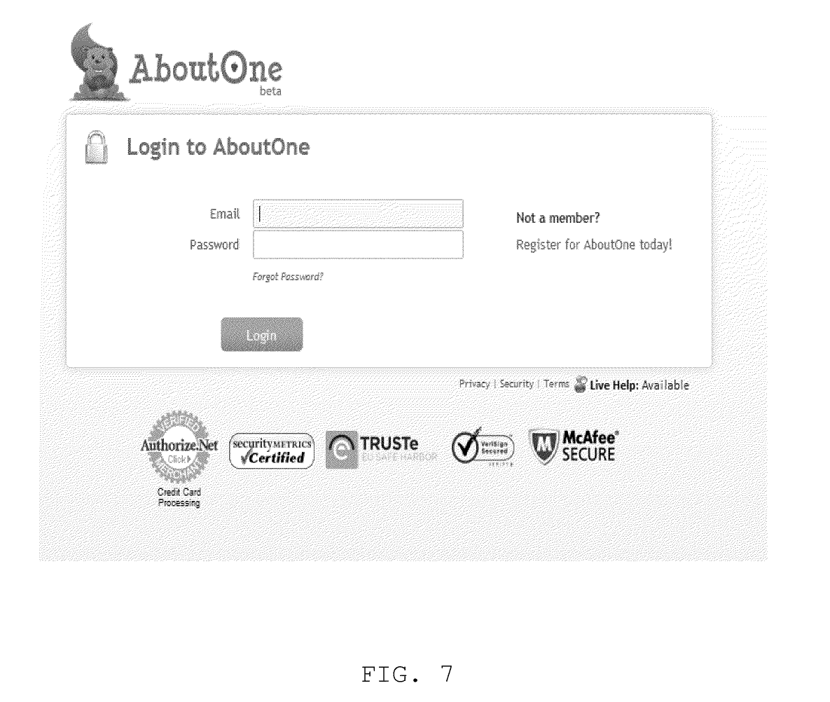

Prior to the start of the process, a user may access a limited portion of the system 10 via a web-enabled device 12 to purchase a subscription to utilize the functionality of the system 10. (See FIG. 5). As part of the subscription process, the user may provide minimal information for billing and identification purposes, and establish a user name and password to uniquely identify the user to the system 10 and to gain subsequent access to and use of the system 10. (See FIG. 6). After the subscription process has been completed, the user may subsequently access the system 10 via any suitable web-enabled device 12 (i.e., via a web browser of the device) communicably connected to the system 10 to log in to the system 10. (See FIG. 7).

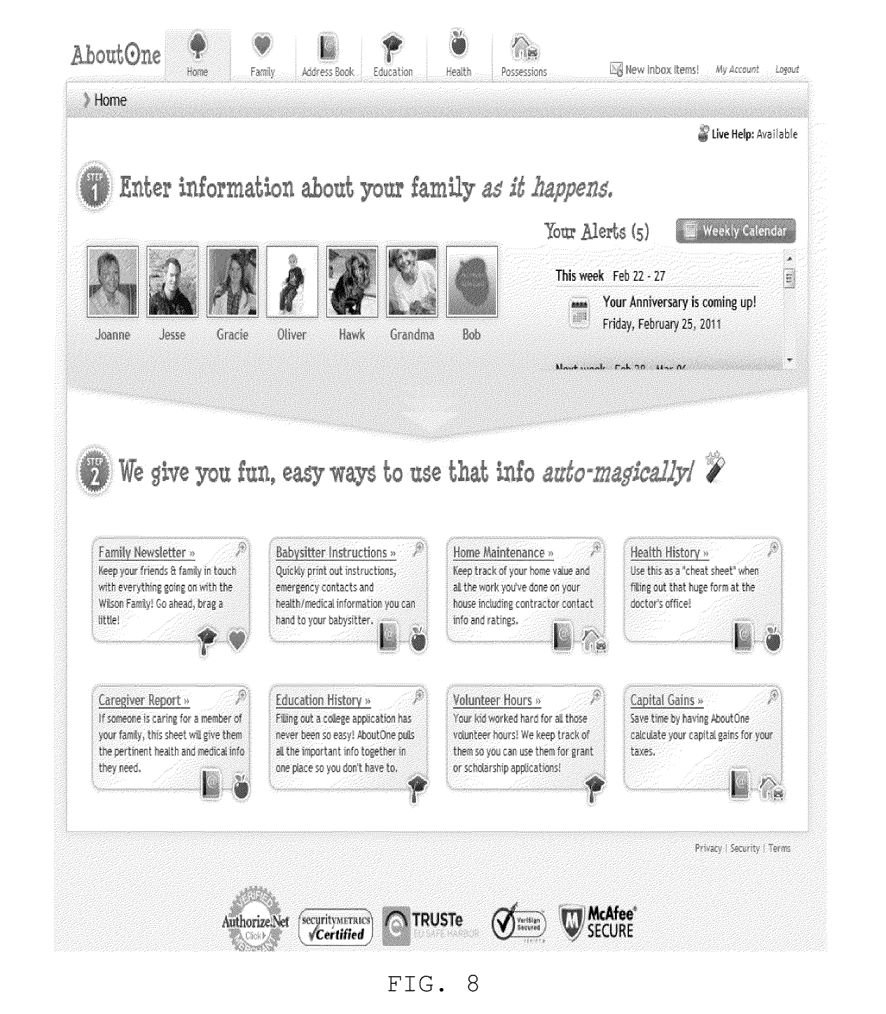

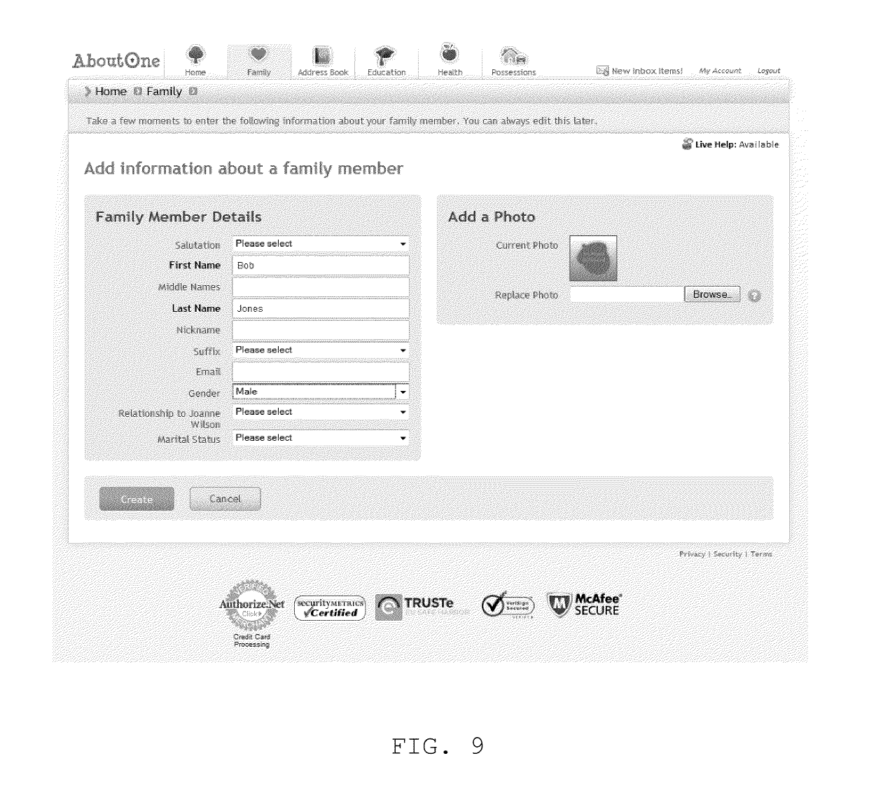

After successfully logging in to the system 10, a “dashboard” view page (See FIG. 8) is presented to the user, and the user may begin entering information into various fields of the dashboard view page. The fields facilitate the entry of information and according to various embodiments, may be organized into various sub-sections such as, for example, family, address book, education, health, possessions, etc. After selecting a particular sub-section, the user may enter as little information as desired (e.g., a single field) or as much information as desired. (See FIG. 9). The user may also attach additional information in the form of photos, documents, etc. to be transmitted to the system 10. After the desired amount of information has been entered and/or attached, the user may select a button (e.g., a “send” button, a “create” button, etc.) on the view page to transmit the entered information to the system 10 for storage in the database at the storage device 22.

The process start at block 62, where the receiving module 26 receives the entered information and assigns the information into one or more respective data fields based on the type of information received. For example, some of the received information may be assigned to “family” data fields, other of the received information may be assigned to “health” data fields, yet other of the received information may be assigned to “education” data fields, etc. According to various embodiments, the receiving module 26 is further configured to instruct the processor 20 to store the received information in the database at the storage device 22. For such embodiments, the system 10 may apply encryption algorithms to the information before storage, whereby the user is the only one who holds the encryption/decryption key, thereby making the stored information unreadable to anyone but the user.

The system 10 is configured to allow a user to enter a single piece of data, then reuse and/or present the data to the user in any number of different view pages. For example, according to various embodiments, a user may enter information regarding a medication associated with a health appointment. The system 10 may then create a second view of that medication independent of the appointment. The system 10 may then “label” a doctor associated with the appointment as the prescribing doctor on a medication record, as a contact in a record in an address book, as a doctor on the user's health record, etc.

According to various embodiments, the receiving module 26 may also receive personal information through a mobile application communicably connected to the system 10. The mobile application may reside, for example, at one of the remote computing systems 14, and allow for direct access to the personal information but through a secondary interface. According to various embodiments, the mobile application allows a user to interact with the personal information but presents a less than complete view of the personal information at any once instance of time.

According to various embodiments, the receiving module 26 may also receive personal information via email communication. For example, a user may send an email containing text, photo, or other attached files to a generalized email address (e.g., inbox@kaboutone.com) associated with the system 10. According to various embodiments, the receiving module 26 (or another module of the system 10) is configured to parse the email message, identify the incoming email address and document types, then correlate the incoming email address to a subscriber account ID from a list stored in the database at the storage device 22. According to various embodiments, the message with attachments may be staged by the system 10 for later processing by the user. Once the user selects the staged message and selects a proper storage location (e.g., through means of a series of drop down menus on a view page), the system 10 appends the correct metadata to the information and instructs the processor 20 to store the received information for later use, view or consumption by the system 10 (e.g., by one or more of the modules 24-36).

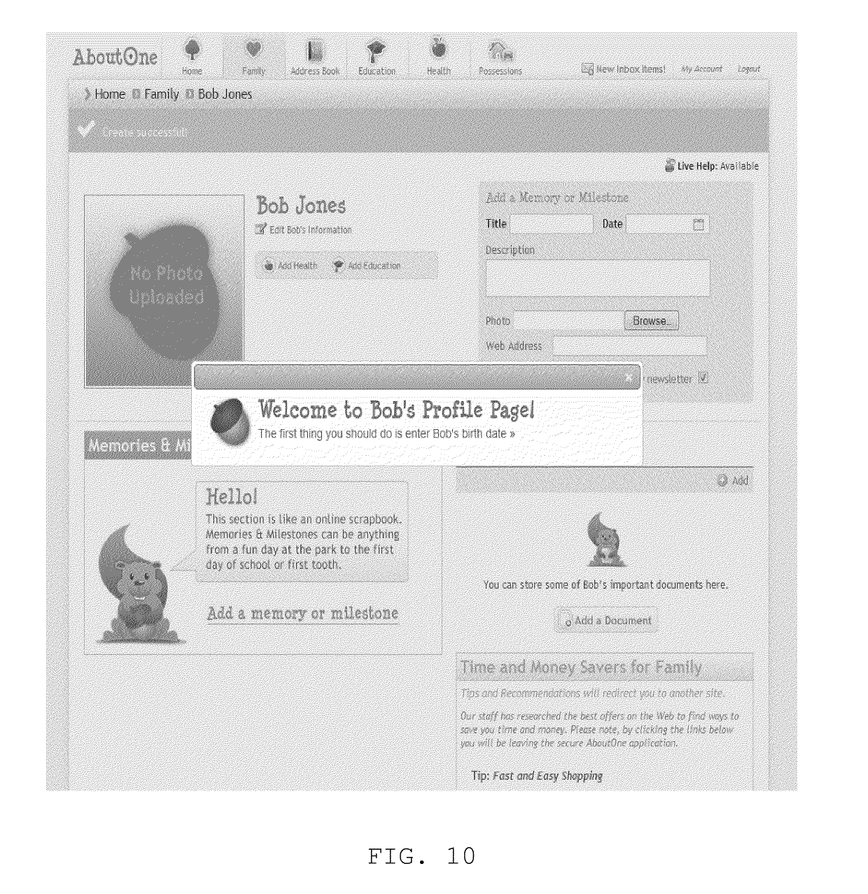

From block 62, the process advances to block 64, where the prompting module 28 prompts the user for additional information to be entered. The prompting module 28 may prompt the user while information is being entered by a user, after information is received by the system 10, etc. For example, according to various embodiments, when a user enters information into a particular field on a view page, the prompting module 28 automatically creates an alert (in this example, an onscreen alert) for the user to enter additional information. (See FIG. 10, prompting the entry of a birth date). An example is when a user enters information about a new family member, the prompting module 28 prompts the user to enter information regarding a birth event (e.g., date of birth, time of birth, length and weight of the baby, hospital name, hospital location, name of delivery doctor, etc).

From block 64, the process advances to block 66, where the build-out module 30 accesses additional personal information from the database at the storage device 22 and/or from databases of the remote computer systems 14 based on information received by the receiving module 26. The accessed additional personal information may be provided to the receiving module 26, then subsequently stored in the database at the storage device 22. According to various embodiments, the information is stored only after the user has verified the accuracy of the information (e.g., by clicking a button on a view page).

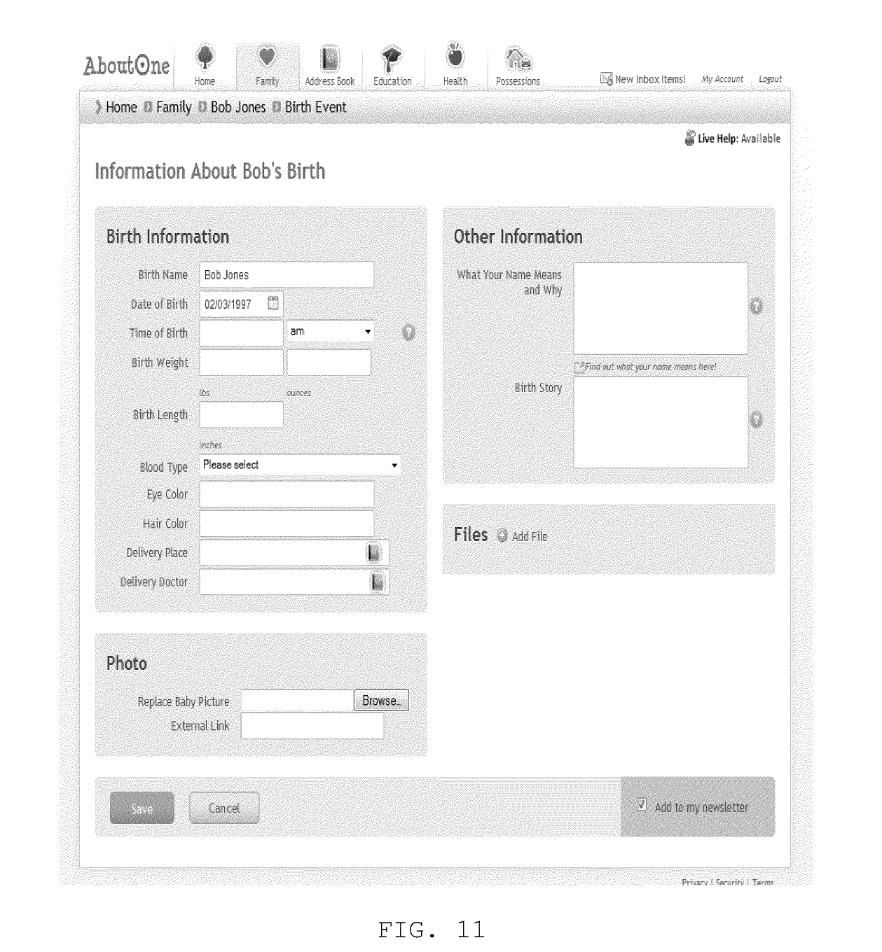

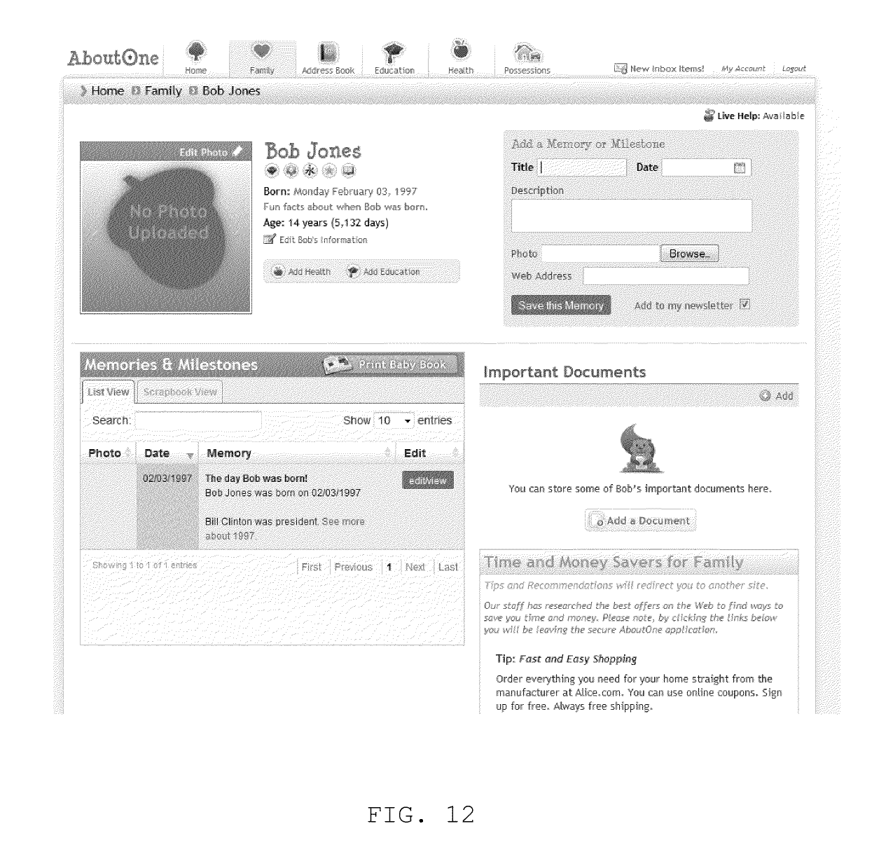

For embodiments where the build-out module 30 accesses and retrieves additional information from the internal database (i.e., the database at storage device 22), the retrieved information may be presented to the user in a read-only state on a view page. Such associated information is not necessarily saved with the user information, but may be called and displayed as needed. For example, if a user enters information regarding a birth date (See FIG. 11), the build-out module 30 may automatically query an internal database for the associated star sign, Chinese year, birth flower, birth stone, etc., as well as for facts from the year of birth, and the system 10 may then present the associated information to the user in a read-only state on a view page. (See FIG. 12).

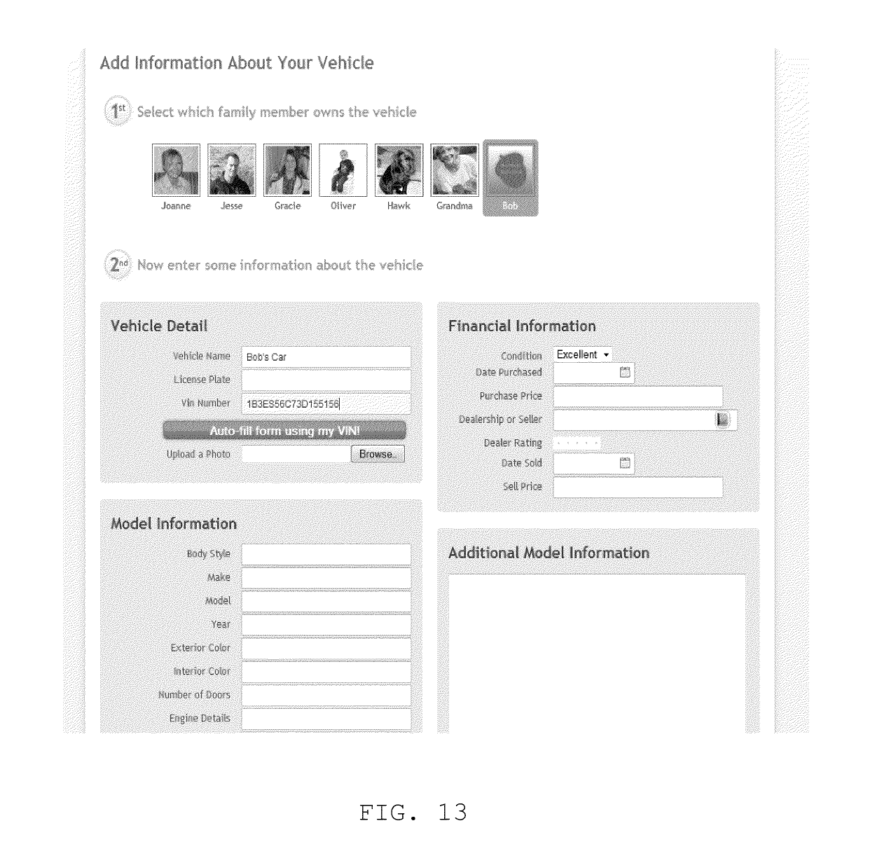

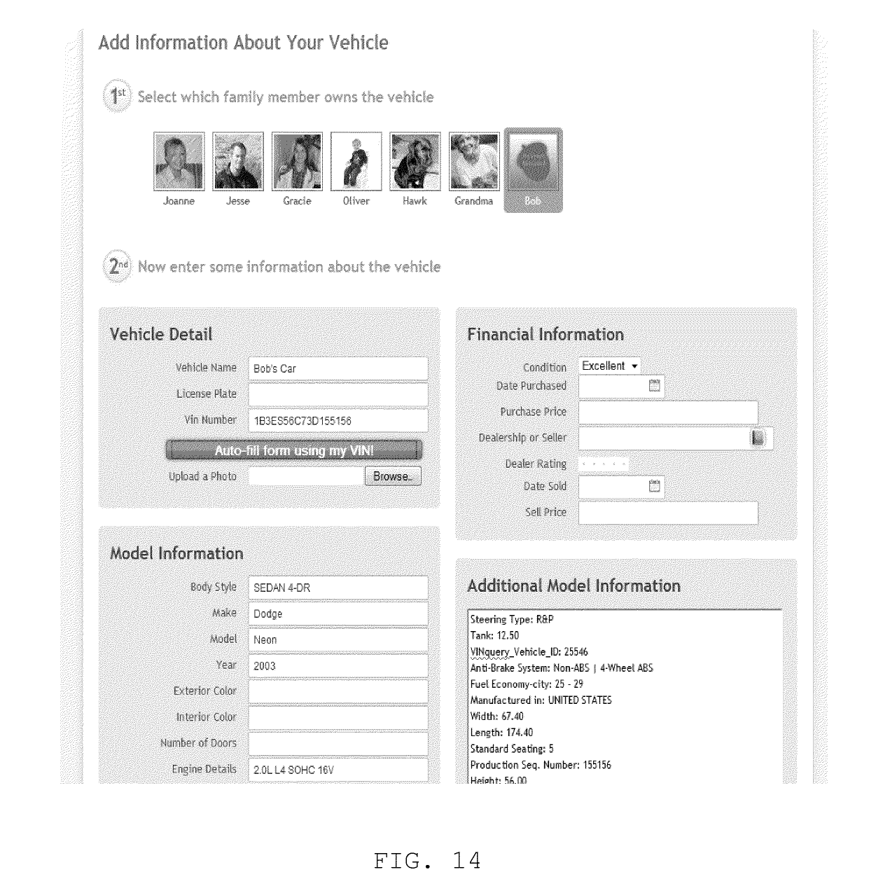

For embodiments where the build-out module 30 accesses and retrieves information from databases of one or more remote computing systems 14, after a user enters information in a certain data field of a view page, the user may click on a button to activate the build-out module 30 to search for additional data related to that field. For example, if the user enters a vehicle identification number (VIN) in a particular field of a view page (See FIG. 13) then activates the build-out module 30, the system 10 may first validate the entered VIN information (e.g., it includes at least 17 numbers), then instruct the build-out module 30 to communicably connect to a particular remote computing system 14 via an application programming interface API. In this manner, the build-out module 30 accesses a database (e.g., Vinquery) of the remote computing system 14 and utilizes the VIN information to retrieve the year, make, model, engine type, etc. associated with the VIN. The retrieved information may then be utilized by the system 10 to automatically populate various data fields of the system 10. The information in the automatically populated data fields is then presented to the user via a view page (See FIG. 14), the presented information may be edited by the user, and the user may select that the presented information be stored in the database at the storage device 22.

From block 66, the process advances to block 68, where the system 10 stores at least some of the received personal information. The stored personal information may be representative of personal information entered by a user, representative of additional personal information entered by a user responsive to a prompt, and/or yet more personal information representative of personal information retrieved from a remote computing system 14.

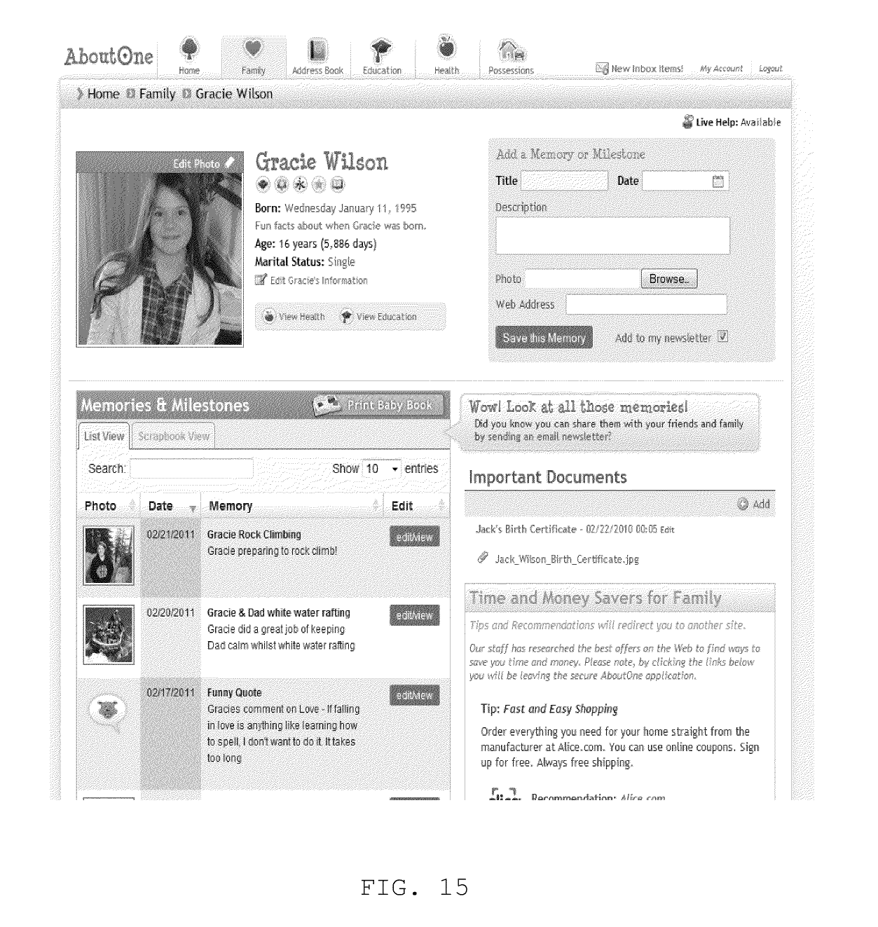

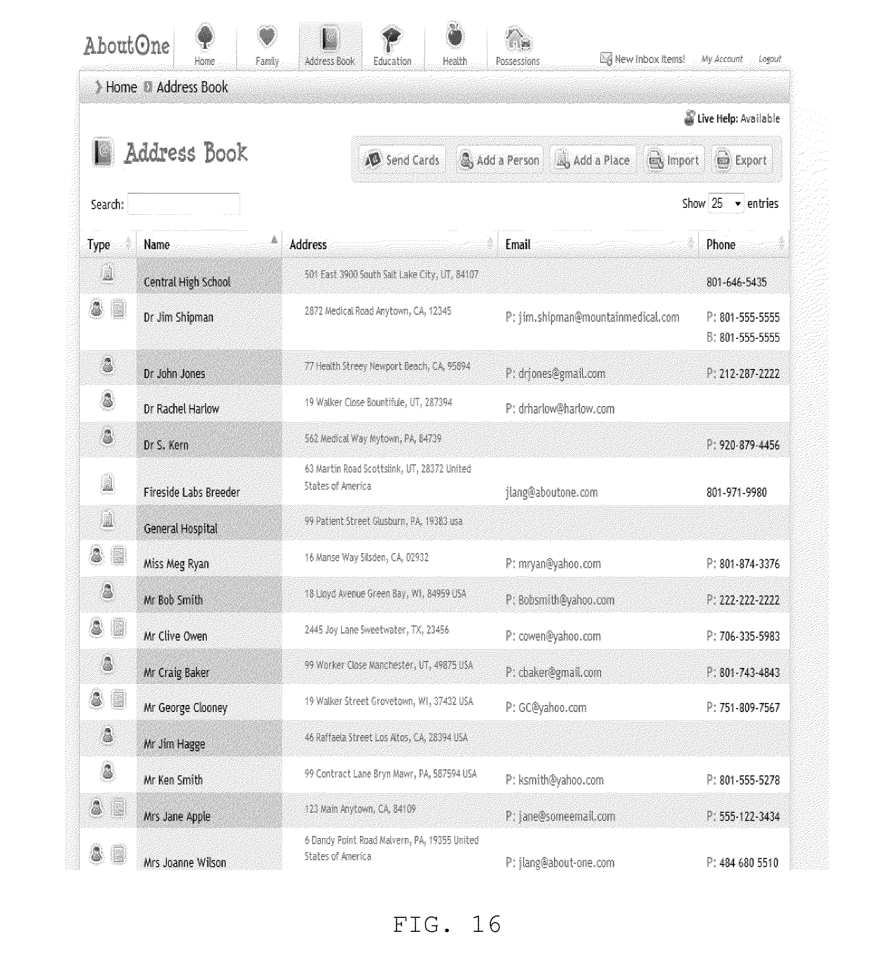

From block 68, the process advances to block 70, where the viewing module 22 formats the stored information for presentation to the user. As described hereinabove, the formatted information may be transmitted to a web browser of a web-enabled device 12, which in turn presents the information to the user via a view page displayed on web-enabled device 12. The viewing module 22 is configured to format the information so that it can be presented in a multitude of different views (i.e., on different view pages). For example, according to various embodiments, some information can be formatted so that it is presented on a view page in a data grid format. (See FIG. 15). According to various embodiments, some information can be formatted so that it can be presented in different configurations (e.g., all of a user's contacts information can be presented in one big data grid on a view page (See FIG. 16), a user can drill down within the one big data grid so that the contacts information is only presented for one person on a view page but with more of the available fields than was presented with the one big data grid). The “one person” view page may also provide access to additional functionality (e.g., gift log functionality) that is not accessible directly from the “one big data grid” view page.

Based on the above description, it will be appreciated that one or more of the actions taken at blocks 62-70 may be performed sequentially, concurrently, in different orders, and may be repeated any number of times. For example, if the prompting at block 64 causes the user to subsequently enter a birth day (i.e., additional information) at block 62, the build-out module 30 may then query the internal database for associated information and facts as described hereinabove with respect to block 66, all while the viewing module 22 is formatting stored information for presentation to the user.

From block 70, the process advances to block 72, where the query module 32 searches the internal database for specific data requested by the user. The user may request the data to be searched by entering the search term into a search field displayed to the user via the web browser. The query module 36 may utilize either information which is visible to the user (e.g., a name of a person or an applied label) or information which is not visible to the user (e.g., metadata) to perform the search within the internal database. The query module 32 then cooperates with the viewing module 22 to present the “results” to the user via a view page.

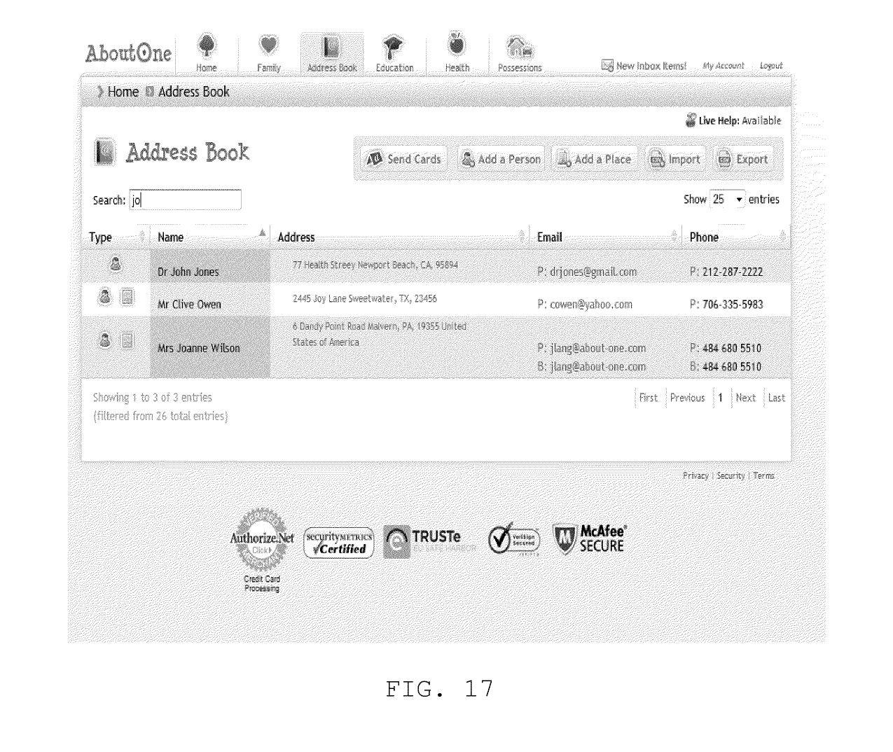

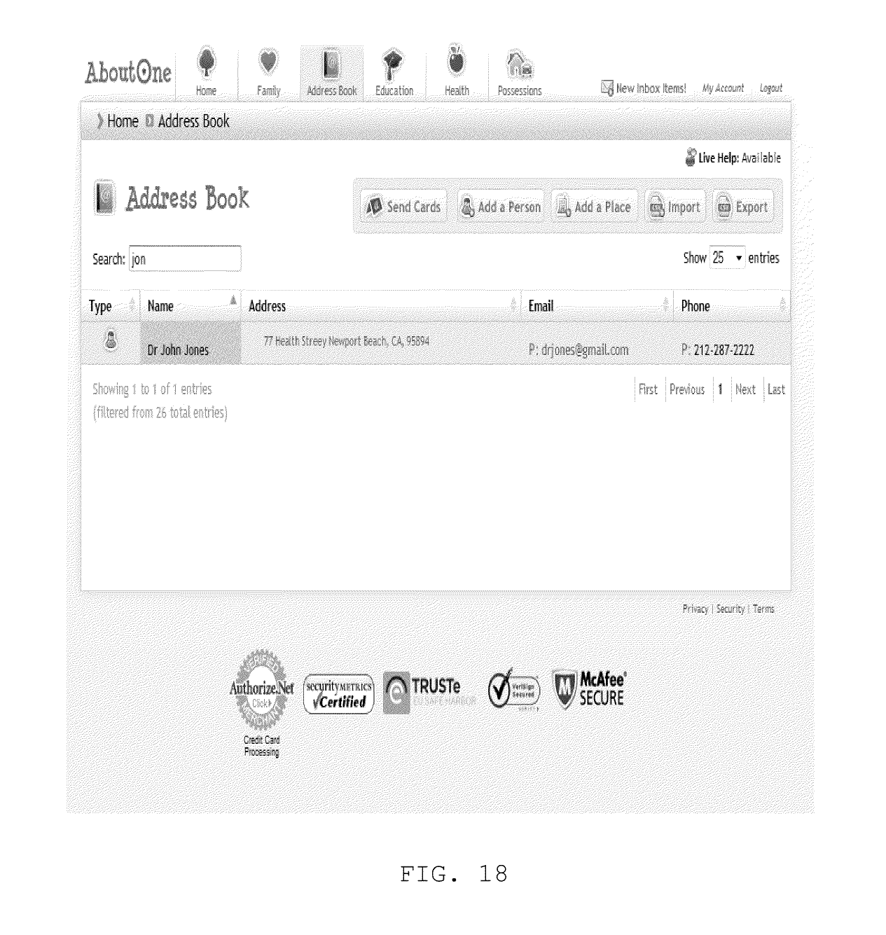

With respect to the use of information which is visible to the user, according to various embodiments, as the user enters all or part of the search term into the search box on the view page, all of the matches found by the query module 36 would be presented to the user on a view page. For example, if the user entered “Jo” to searching for Jonathan (See FIG. 17), the query module 32 would identify anything containing those 2 letters within the address book area, and the results would then be presented to the user. As the user added the next letter to make the search string “Jon”, the query module 32 would begin narrowing the presented results. (See FIG. 18). With respect to the use of information which is not visible to the user, according to various embodiments, the query module 32 utilizes metadata (e.g., person ID=326 and aspect area=health) to identify “matches” to the search term. This may happen through the use of SQL statements or other means. The query module 32 may also utilize predefined search and sort parameters identified by the user via interaction with the user interface. For example, by the user selecting a button at the top of any column of a data grid on a view page, the query module 32 will sort the information in that field in ascending or descending order.

From block 72, the process advances to block 74, where the leveraging module 34 utilizes information stored by the system 10 to automatically perform organizational tasks historically performed by the user. The action taken at block 72 may result in the creation of a new digital or physical artifact that is a sum or more than the sum of the received personal information. Thus, through the creation of the artifact, the system 10 and method 60 provide more information than what is simply entered into the system 10, and the format of the created artifact may be different than the format of the information originally entered in the system 10.

The leveraging module 34 may be activated when a user selects a predefined task. According to various embodiments, once activated, the leveraging module 34 sends a query request to the query module 32 for a predefined dataset necessary to complete the action. The returned dataset may be presented to the user for validation, then forwarded to a remote computing system 14. The remote computing system 14 may then pass back a success confirmation that would be presented to the user. The above-described sequence may be utilized by a user to arrange to have Christmas cards, invitations, thank you cards, etc. created and sent to a plurality of people. For example, the user may select a label or enter search criteria into a search box on a view page to select a group of addresses. The leveraging module 34 then sends a query request to the query module 32 for the requested group of addresses. The user may then press a button (e.g., a “send” button, a “create” button, etc.) on a view page to send the retrieved group of addresses (as well as the user's name and address) to a particular remote computing system 14 which hosts a “card” application. The user is then redirected to “card” application to complete the transaction.

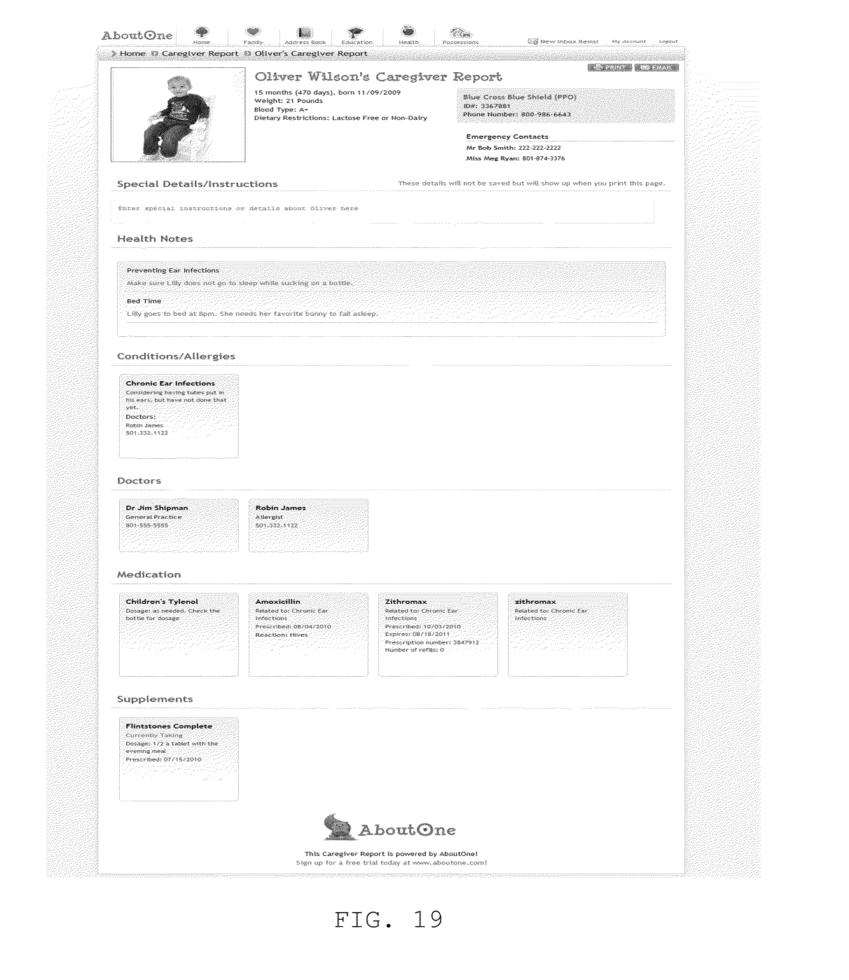

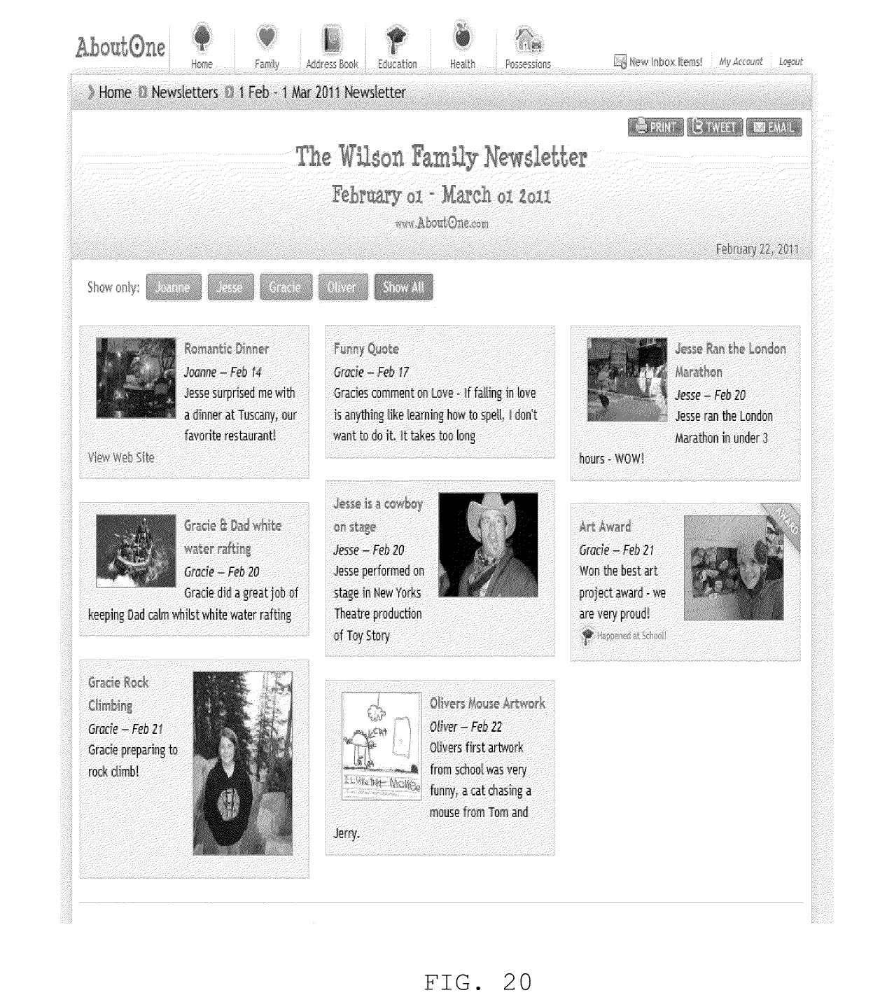

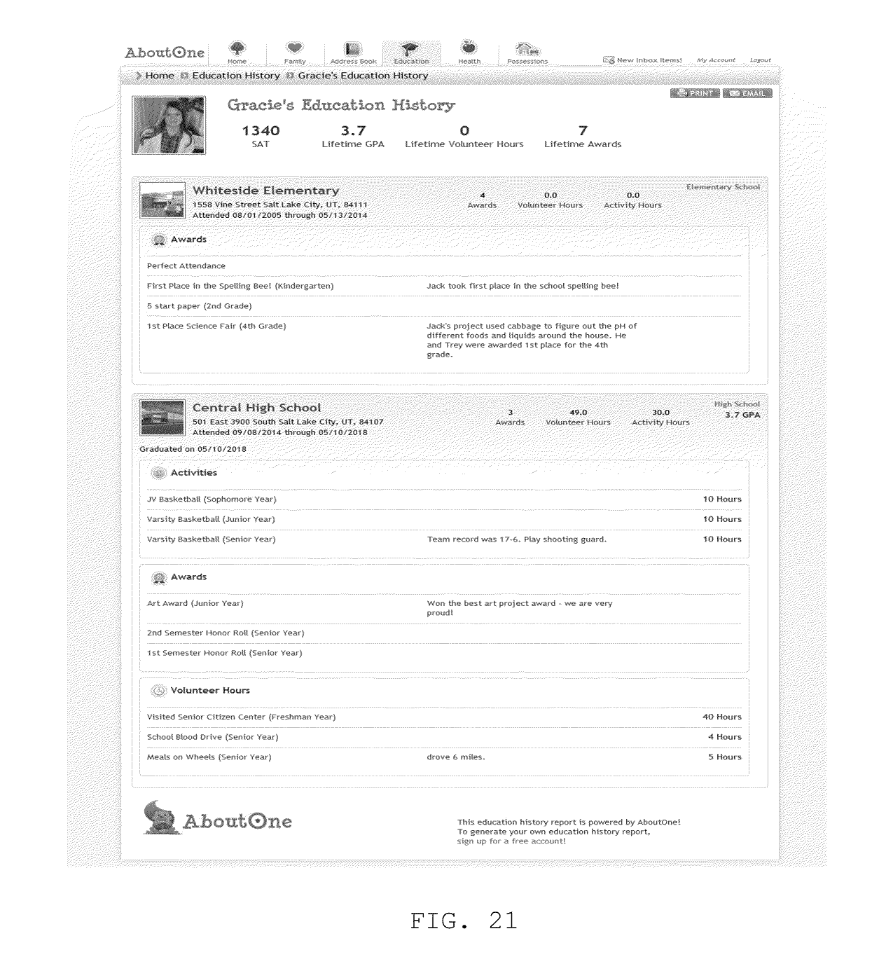

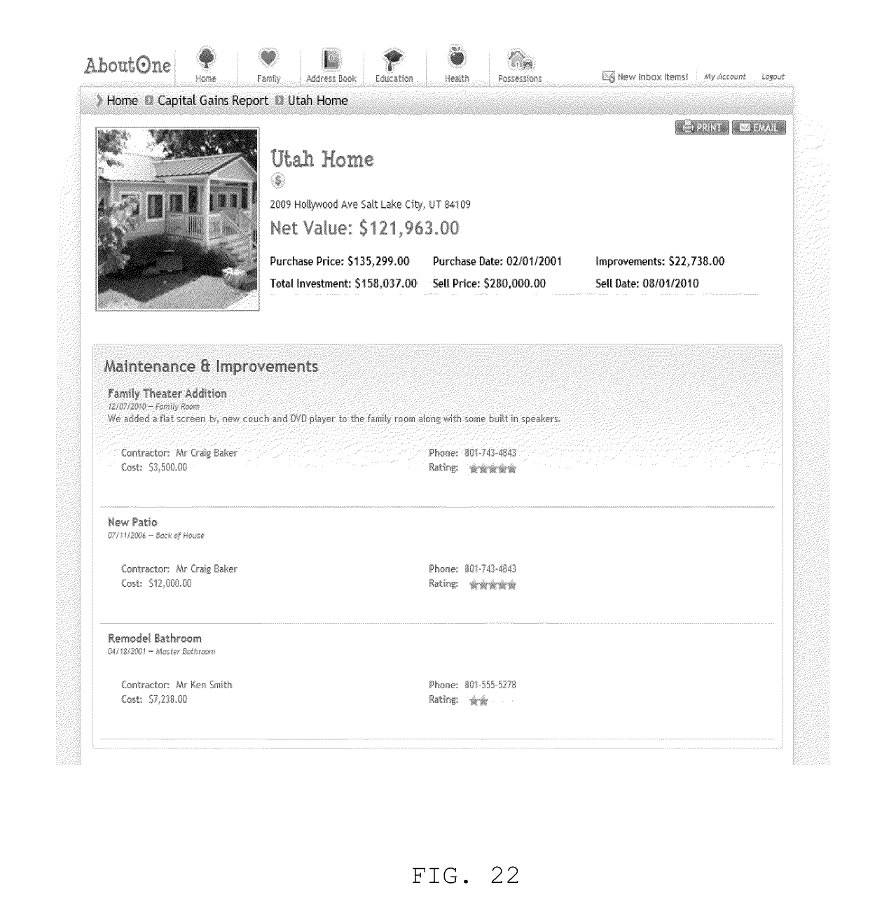

According to other embodiments, information may not be forwarded to a remote computing system 14. For such embodiments, the leveraging module 34 may request the viewing module 22 to generate a special view of the information. For example, the leveraging module 34 may utilize information stored by the system 10 to generate a report such as, for example, a caregiver report (See FIG. 19) for a babysitter, a “family newsletter” report (See FIG. 20), an education history report (See FIG. 21), a capital gains report for a home (See FIG. 22), etc. The reports can be printed, emailed to others, sent to others via social media, etc. The generated product may be considered an interactive report, with additional features available to the user (e.g., additional filters and sharing mechanisms).

From block 74, the process proceeds to block 76, where the advisory module 36 determines organizational suggestions and/or advice for the user. According to various embodiments, the query module 32 (either on event or on a schedule) determines the suggestions and/or advice by comparing user data to rules in the advisory module 36. When there is a match between the user data and one or more of the rules, the advisory module 36 cooperates with the viewing module 22 (or other modules of the system 10) to present one or more of the determined suggestions to the user. The suggestion may be presented to the user in any suitable manner. For example, according to various embodiments, the suggestion is presented to the user on a view page. According to other embodiments, the suggestion is presented to the user via an email. The user has the option to take action on the suggestion (via a link to another area in the system 10) or ignore the suggestion.

Using the high school student example described hereinabove, the system 10 knows that the user has a child of a certain age who attends a high school but has not yet graduated from the high school. The advisory module 36 determines the existence of a match between this information and a rule in the advisory module 36, then cooperates with one or more other modules of the system 10 to present a suggestion to the user, where the suggestion is for the user to begin memorializing student information (e.g., awards earned, school activities participated in, volunteer efforts, etc.) in preparation for college applications. According to various embodiments, the suggestion may also be paired with an external link or discount that could be of further benefit to the user.

Based on the above description, it will be appreciated that one or more of the actions taken at blocks 72-76 may be performed sequentially, concurrently, in different orders, and may be repeated any number of times. Furthermore, any of the actions taken at blocks 72-76 may also be performed while one or more of the actions taken at blocks 62-70 are being performed. Also any of the actions taken at blocks 62-76 for one user may also be performed concurrently with any of the actions taken at blocks 62-76 for other users.

In addition to the actions taken at blocks 62-76, the method 60 may further include the system 10 taking additional sequential and/or concurrent actions. For example, in addition to the actions taken at blocks 62-76, the system 10 may also periodically search all of the stored user information for specific events which the system utilizes to generate a scheduled alert or email. For example, according to various embodiments, the system 10 periodically (e.g., each night) searches, for each user, the stored information for upcoming birthdays associated with the user. The system 10 utilizes the identified upcoming birthdays to generate emails/reminders which are presented to the user. For each birthday, the system 10 may send one email two weeks before the birthday and another email the day of the birthday. The two emails may include different information. According to various embodiments, the email sent on the day of the birthday may include additional information such as, for example, facts from the day that person was born, a link back to the person contact page so you can enter additional information like gift ideas, etc.

Another example is that if a user enters medication information which includes an expiration date of the medication, the system 10 will periodically look for upcoming expiration dates and create an email reminder to be sent out in advance of that expiration date.

Other examples of additional actions taken by the system 10 include the system 10 performing predefined queries to generate specific reports. The predefined queries may span multiple sections of the system 10 with a defined view. For example, in order for the system 10 to generate a health report, the system 10 queries the stored information for all relevant health information. In order for the system 10 to generate a babysitter report, the system 10 queries several areas of the stored information within a limited range of dates. In order for the system 10 to generate a capital gains report, the system 10 queries all of the transactional records of an asset, then presents the transactional records with a calculation showing the capital gains amount.

Yet other examples of additional actions taken by the system 10 include routinely searching the stored information for upcoming medical appointments, and presenting an alert to a user regarding the same. According to various embodiments, the alert may be presented on a view page in the form of a link, which when “clicked”, takes the user to the log in view page. Once logged in to the system 10, the user may view the appointment, update the appointment and/or enter new information associated with the appointment, etc. According to other embodiments, the system 10 may also present a prompt to the user after the scheduled appointment. The prompt may be presented to the user via an email, and the email may include a question such as, for example “How did your appointment on Tuesday go”? When the user sends a reply email back to the system 10, the system 10 may parse the contents of the reply message, and store the contents of the reply message in applicable fields, all without requiring the user to log in to the system 10.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the invention as recited in the following claims. Accordingly, it is understood that the drawings and the descriptions herein are proffered only to facilitate comprehension of the invention and should not be construed to limit the scope thereof.

What is claimed is:

1. A system for managing personal information, the system comprising:
a computing device, wherein the computing device comprises a processor;
a receiving module communicably connected to the processor, wherein the receiving module is configured to receive first personal information;
a storage device communicably connected to the processor, wherein the storage device is configured to store the received first personal information;
a build out module communicably connected to the processor, wherein the build out module is configured to automatically retrieve second personal information based on the received first personal information; and
a leveraging module communicably connected to the processor, wherein the leveraging module is configured to utilize the stored information to automatically perform an organizational task historically performed by a person.

2. The system of claim 1, wherein the build-out module is further configured to automatically retrieve the second personal information from at least one of the following:
the storage device; and
a remote computing system.

3. The system of claim 1, wherein the leveraging module is further configured to utilize the stored information to create a report.

4. The system of claim 1, wherein the leveraging module is further configured to utilize the stored information to create a new artifact.

5. The system of claim 1, wherein the system further comprises a viewing module communicably connected to the processor, wherein the viewing module is configured to format a view page for presentation.

6. The system of claim 1, wherein the system further comprises a prompting module communicably connected to the processor, wherein the prompting module is configured to transmit a message to prompt a person to input third personal information to the system.

7. The system of claim 1, wherein the system further comprises a query module communicably connected to the processor, wherein the query module is configured to search the stored information for specific data.

8. The system of claim 1, wherein the system further comprises an advisory module communicably connected to the processor, wherein the advisory module is configured to determine a suggested action to improve an overall organization of a person.

9. The system of claim 1, wherein the system is configured to apply an encryption algorithm to the received first personal information before the received first personal information is stored at the storage device.

10. The system of claim 1, wherein the system is configured to format the stored personal information so that at least some of the stored personal information can be accessed by a plurality of persons.

11. A method, implemented at least in part by a computing device, for managing personal information, the method comprising:
receiving first personal information at the computing device;
at the computing device, receiving second personal information based on the received first personal information;
storing at least one of the received first and second personal information at a storage device communicably connected to the computing device; and
automatically performing an organizational task historically performed by a person, wherein the organizational task is performed by the computing device.

12. The method of claim 11, wherein receiving the second personal information comprises querying a database based on the received first personal information, wherein the database is communicably connected to the computing system.

13. The method of claim 12, wherein querying the database comprises querying a database at a remote computing system via an application programming interface.

14. The method of claim 11, wherein performing the organization tasks comprises generating a report.

15. The method of claim 11, wherein performing the organization tasks comprises creating a new artifact.

16. The method of claim 11, further comprising formatting a view page for presentation.

17. The method of claim 11, further comprising searching the stored information, wherein the searching is performed by the computing device.

18. The method of claim 11, further comprising determining a suggested action to improve an overall organization of a person, wherein the determining is performed by the computing device.

19. The method of claim 11, further comprising encrypting at least one of the received first and second personal information before storing the at least one of the received first and second personal information.

20. The method of claim 11, further comprising formatting the stored information so that at least some of the stored information can be accessed by a plurality of persons.
